(19) United States
(12) Patent Application Publication
(10) Pub. No.: US 2026/0315300 A1
(43) Pub. Date: Oct. 15, 2026

(54) ELASTIC MEMBER DRIVEN FINGER EXOSKELETON MECHANISM AND HAND EXOSKELETON MECHANISM

(71) Applicant: Nanchang University, Nanchang (CN)

(72) Inventors: Zhiwei MAO, Nanchang (CN); Wei ZHANG, Beijing (CN); Shufeng WANG, Beijing (CN); Wenjun LI, Beijing (CN); Lixu LIU, Beijing (CN)

(73) Assignee: Nanchang University, Nanchang (CN)

(21) Appl. No.: 19/463,320

(22) Filed: Jan. 29, 2026

Related U.S. Application Data
(63) Continuation of application No. PCT/CN2025/143058, filed on Dec. 17, 2025.

(30) Foreign Application Priority Data
Nov. 19, 2024 (CN) 2024116571302

(51) Int. Cl. A61H 1/02

(52) U.S. Cl. CPC A61H 1/0288; A61H 2201/149; A61H 2201/1638

(57) ABSTRACT

Disclosed are an elastic member driven finger exoskeleton mechanism and a hand exoskeleton mechanism in the technical field of finger exoskeletons. The finger exoskeleton mechanism includes an elastic driving member disposed adjacent to a back of a hand, the elastic driving member being extendable and retractable and capable of flexion and extension movement; and a plurality of links. One end of each link forms a hand fixation pair with a finger segment or a palm, and the other end forms an elastic driving member fixation pair with an end portion of the elastic driving member and a composite kinematic pair with a non-end portion thereof. The elastic driving member has a bending working state and an extension working state. The mechanism can independently drive bending of a plurality of finger segments, and has advantages of better finger protection, stronger hand size compatibility, and multiple degrees of freedom.

### CROSS-REFERENCE TO RELATED APPLICATIONS

The application claims priority to Chinese patent application No. 2024116571302, filed on Nov. 19, 2024, the entire contents of which are incorporated herein by reference.

### TECHNICAL FIELD

The present disclosure relates to the technical field of finger exoskeletons, and specifically relates to an elastic member driven finger exoskeleton mechanism. Based on this, the present disclosure further relates to an elastic member driven hand exoskeleton mechanism.

### BACKGROUND

With the aggravation of the problem of population aging and the increase in limb injuries caused by work-related injuries, traffic accidents, and the like, the demand for hand rehabilitation is increasing day by day. Traditional hand rehabilitation treatment mainly relies on manual operation by a physical therapist, but the manual operation is not only time-consuming and laborious, but also difficult to ensure the precision and consistency of the treatment. Therefore, developing a robotic device capable of assisting in hand rehabilitation to achieve automation and precision of a rehabilitation process has important clinical significance and application value.

Research on hand exoskeletons began in the early 1990s, initially applied in the field of master-slave operation, such as robotic hand control for astronauts' extravehicular activities. With the continuous advancement of technology, the hand exoskeleton has been gradually applied to the field of rehabilitation engineering, becoming an important auxiliary tool for hand rehabilitation.

Technical solutions for hand exoskeletons are mainly divided into three categories: a soft exoskeleton, a soft-rigid hybrid hand exoskeleton, and a rigid hand exoskeleton.

The soft hand exoskeleton has good flexibility and a small structural dimension, and conforms to the hand well, but due to conforming to the hand, a moment arm for driving a finger joint to rotate is short, and a ratio of a joint rotational torque to a driving force is low. The soft hand exoskeleton mainly includes two types: cable-driven and pneumatic drive. Since the cable-driven type can only provide a pulling force, each joint drive requires 2 driving motors or a combination of 1 driving motor and an added movable pulley, resulting in complicated overall wiring, poor hand size compatibility, a need for customization according to a size of a hand of a patient, a heavy overall weight, and high manufacturing cost. Compared with the cable-driven type, the pneumatic drive has good hand size compatibility, but the ratio of the hand joint driving torque to the driving force is lower, the gripping force is small, and servo control accuracy of position and speed is poor.

For the soft-rigid hybrid hand exoskeleton, motion of each joint of a finger cannot be independently controlled, which greatly reduces dexterity of the finger compared with a physiological structure of the finger, few postures of the hand can be controlled to be formed, and many rehabilitation actions cannot be realized. Since the driving force drives a distal phalanx of the finger, the ratio of the joint rotational torque of each joint of the finger to the driving force is low, resulting in a small gripping force. More seriously, due to a large component force of the driving force in a direction perpendicular to an axis of rotation of the joint, pressure on three joints of the finger is large, easily causing joint injury. Secondly, rigidity in a direction perpendicular to joint rotation during flexion and extension of the finger is large, restriction on opening and closing of the finger is strict, and meanwhile, when wearing is not aligned, discomfort is caused to the patient.

The rigid hand exoskeleton represented by a linkage mechanism has a large number of mechanism components, a large dimension, a large motion space, and a heavy weight. Meanwhile, aligning a kinematic pair of the mechanism with the joint is difficult, easily causing misalignment, thereby causing a feeling of discomfort to the patient, and even causing damage to the joint of the patient. Hand size compatibility is poor, and when hand sizes of different patients change, replacing components in the mechanism is usually required for accommodation. In addition, since the finger joints have as many as 21 degrees of freedom, the rigid hand exoskeleton mechanism has strict restrictions on the remaining joint degrees of freedom except for the controlled joint degrees of freedom. When the patient has a certain movement ability regarding the degrees of freedom restricted by the mechanism, the restriction is unfavorable for hand rehabilitation training.

### SUMMARY

Provided in the present disclosure is an elastic member driven finger exoskeleton mechanism and a hand exoskeleton mechanism, to overcome at least one of the above technical problems existing in the prior art. The finger exoskeleton mechanism has advantages such as better protection performance for a finger and stronger hand size compatibility.

To achieve the above object, according to a first aspect of the present disclosure, provided is an elastic member driven finger exoskeleton mechanism, including: an elastic driving member disposed at a side adjacent to a back of a hand and configured to extend and retract and perform flexion and extension movement; and a plurality of links. One end of the link forms a hand fixation pair with a finger segment and a palm, the other end of the link forms an elastic driving member fixation pair with an end portion of the elastic driving member, and the other end of the link forms a composite kinematic pair with a non-end portion of the elastic driving member. The composite kinematic pair is configured to cause the elastic driving member to perform the flexion and extension movement. The elastic driving member has the following working states: a bending working state, where when the elastic driving member extends, the elastic driving member performs a bending movement toward a direction of a palm center; and an extension working state, where when the elastic driving member retracts, the elastic driving member performs an extension movement toward a direction away from the palm center.

In the above technical solution, the elastic driving member is connected to the finger segment (e.g., a distal phalanx, a middle phalanx, a proximal phalanx) or the palm sequentially through the elastic driving member fixation pair, the link, and the hand fixation pair. The elastic driving member is configured to be capable of bending and rotating and capable of extending and retracting. The elastic driving member extends and retracts by loading a moving drive or manual actuation on the elastic driving member, such that the elastic driving member has the bending movement working state and the extension movement working state. Specifically, when the elastic driving member extends, a length of the elastic driving member between two elastic driving member fixation pairs increases at this time, and a length of the finger of a person is fixed, so the elastic driving member bends toward the direction of the palm center to accommodate an increase in the length of the elastic driving member between the two elastic driving member fixation pairs, thereby driving a hand joint between the two elastic driving member fixation pairs to rotate toward the direction of the palm center to bend the finger. Similarly, when the elastic driving member retracts, the elastic driving member rotates toward the direction away from the palm center to accommodate a decrease in the length of the elastic driving member between the two elastic driving member fixation pairs, thereby driving the finger to extend.

In the finger exoskeleton mechanism provided by the present disclosure, the hand fixation pair is connected to the finger segment or the palm and does not need to be aligned with a finger joint, which is convenient for wearing. Compared with aligning the hand fixation pair with the finger joint, achieving alignment of the hand fixation pair with the finger segment is relatively easy, and misalignment is not likely to occur during use to result in a feeling of discomfort of a user or even damage the finger joint. Meanwhile, the finger exoskeleton mechanism is also allowed to have better compatibility with different sizes of hands. When hand sizes of different users change, there is no need to customize or replace components in the finger exoskeleton mechanism, saving economic costs. Moreover, as described above, the bending of the finger is achieved by the extension of the elastic driving member increasing a curve length between the two elastic driving member fixation pairs. Thus, by increasing the length of the elastic driving member between different elastic driving member fixation pairs, different finger joints can be bent, thereby accommodating needs of different rehabilitation treatments. Based on this, the finger exoskeleton mechanism provided by the present disclosure can further achieve independent control of bending of different finger joints to achieve more postures of the hand.

Additionally, the finger exoskeleton mechanism of the present disclosure uses the elastic driving member to drive the finger to bend. When the moving drive loads an excessive driving force on the elastic driving member, if a non-elastic driving member, such as a steel cable, is adopted, the excessive driving force transmits a large force to the finger joint during a process of bending the steel cable, increasing a risk of finger joint injury. However, since the elastic driving member itself has certain elasticity, the elastic driving member buffers a part of the excessive driving force during a bending process, thereby protecting the finger joint.

In some embodiments, the hand fixation pair includes a first fixed pair formed by connecting the distal phalanx and a first link, a third fixed pair formed by connecting the middle phalanx and a second link, a fifth fixed pair formed by connecting the proximal phalanx and a third link, and a seventh fixed pair formed by connecting the palm and a fourth link.

In some embodiments, the elastic driving member fixation pair includes a second fixed pair, a fourth fixed pair, a sixth fixed pair, and an eighth fixed pair formed by connecting the elastic driving member with the first link, the second link, the third link, and the fourth link, respectively.

In some embodiments, the elastic driving member includes a first elastic driving member having an end portion connected to the first link to form the second fixed pair, a second elastic driving member having an end portion connected to the second link to form the fourth fixed pair, and a third elastic driving member having an end portion connected to the third link to form the sixth fixed pair.

In some embodiments, the composite kinematic pair includes a first composite kinematic pair formed by connecting the second link and the first elastic driving member, a second composite kinematic pair formed by connecting the third link with the first elastic driving member and the second elastic driving member, and a third composite kinematic pair formed by connecting the fourth link with the first elastic driving member, the second elastic driving member, and the third elastic driving member.

In some embodiments, the finger exoskeleton mechanism further includes a moving drive loaded on the elastic driving member to cause the elastic driving member to perform extension and retraction movement.

In some embodiments, the moving drive includes a first moving drive loaded on the first elastic driving member, a second moving drive loaded on the second elastic driving member, and a third moving drive loaded on the third elastic driving member.

In some embodiments, the composite kinematic pair includes a translation and rotation composite pair, where the translation and rotation composite pair is configured to cause the elastic driving member to perform axial movement and flexion and extension movement.

In some embodiments, the composite kinematic pair includes a cylindrical and rotation composite pair, where the cylindrical and rotation composite pair is configured to be capable of causing the elastic driving member to perform axial movement, flexion and extension movement, and rotation about a central axis of the cylindrical and rotation composite pair.

In some embodiments, the elastic driving member is made of a polytetrafluoroethylene material.

According to a second aspect of the present disclosure, provided is an elastic member driven hand exoskeleton mechanism, including a plurality of the elastic member driven finger exoskeleton mechanisms described above, where the plurality of finger exoskeleton mechanisms are correspondingly mounted to different fingers.

Other features and advantages of the embodiments of the present disclosure will be described in detail in the following Detailed Description section.

### BRIEF DESCRIPTION OF DRAWINGS

FIG. 1 illustrates a schematic diagram of the structure of an elastic member driven finger exoskeleton mechanism disclosed in the present disclosure.

FIG. 2 illustrates a schematic diagram of the finger exoskeleton mechanism disclosed in the present disclosure driving a proximal phalanx to bend and rotate about a palm.

FIG. 3 illustrates a schematic diagram of the finger exoskeleton mechanism disclosed in the present disclosure driving the proximal phalanx to bend and rotate about the palm.

FIG. 4 illustrates a schematic diagram of the finger exoskeleton mechanism disclosed in the present disclosure driving the proximal phalanx to bend and rotate about the palm.

FIG. 5 illustrates a schematic diagram of the structure of the finger exoskeleton mechanism disclosed in the present disclosure, not including a second elastic driving member, a third elastic driving member, and associated connecting members.

FIG. 6 illustrates a schematic diagram of the structure of the finger exoskeleton mechanism disclosed in the present disclosure, not including a first elastic driving member, the third elastic driving member, and associated connecting members.

FIG. 7 illustrates a schematic diagram of the structure of the finger exoskeleton mechanism disclosed in the present disclosure, not including the first elastic driving member and associated connecting members.

FIG. 8 illustrates a schematic diagram of the structure of the finger exoskeleton mechanism disclosed in the present disclosure, not including the first elastic driving member, the second elastic driving member, and associated connecting members.

### DESCRIPTION OF REFERENCE NUMERALS

distal phalanx; 2—middle phalanx; 3—proximal phalanx; 4—palm; 5—first fixed pair; 6—first link; 7—second fixed pair; 8—first cylindrical and rotation composite pair; 9—third fixed pair; 10—second link; 11—fourth fixed pair; 12—first center of rotation; 13—fifth fixed pair; 14—third link; 15—sixth fixed pair; 16—second cylindrical and rotation composite pair; 17—second center of rotation; 18—seventh fixed pair; 19—fourth link; 20—eighth fixed pair; 21—third cylindrical and rotation composite pair; 22—third center of rotation; 23—first elastic driving member; 24—second elastic driving member; 25—third elastic driving member; 26—first moving drive; 27—second moving drive; 28—third moving drive.

### DETAILED DESCRIPTION OF THE EMBODIMENTS

The specific embodiments of the present disclosure are described in detail below with reference to the accompanying drawings. It should be understood that the specific embodiments described herein are merely for describing and explaining the present disclosure and are not intended to limit the present disclosure.

In the present disclosure, unless otherwise stated to the contrary, orientation or positional relationships indicated by terms such as “upper”, “lower”, “left”, “right”, “inner”, “outer”, “top”, and “bottom” are based on the orientation or positional relationships shown in the accompanying drawings, are merely for facilitating the description of the present disclosure and simplifying the description, and do not indicate or imply that the indicated device or element must have a specific orientation or be constructed and operated in a specific orientation, and thus cannot be understood as a limitation on the present disclosure.

Furthermore, terms such as “first” and “second” are used for descriptive purposes only and cannot be understood as indicating or implying relative importance or implicitly indicating the number of indicated technical features. Thus, a feature defined with “first” or “second” may explicitly or implicitly include at least one such feature. In the description of the present disclosure, the meaning of “a plurality of” is at least two, for example, two, three, etc., unless explicitly and specifically defined otherwise.

In the present disclosure, descriptions referring to terms such as “one embodiment”, “some embodiments”, “an example”, “a specific example”, or “some examples” mean that specific features, structures, materials, or characteristics described in combination with the embodiment or example are included in at least one embodiment or example of the present disclosure. In this specification, schematic representations of the above terms do not necessarily refer to the same embodiment or example. Moreover, the described specific features, structures, materials, or characteristics may be combined in any suitable manner in any one or more embodiments or examples. Furthermore, without mutual conflict, a person of ordinary skill in the art may combine and assemble different embodiments or examples described in this specification and features of different embodiments or examples.

In the present disclosure, unless otherwise explicitly provided and defined, terms such as “mount”, “connected”, “connect”, and “fix” should be understood in a broad sense. For example, they may be fixed connections, detachable connections, or integrated; they may be mechanical connections, electrical connections, or mutual communication; they may be directly connected, or indirectly connected through an intermediate medium, and may be internal communication between two elements or an interaction relationship between two elements, unless otherwise explicitly defined. For a person of ordinary skill in the art, specific meanings of the above terms in the present disclosure may be understood according to specific situations.

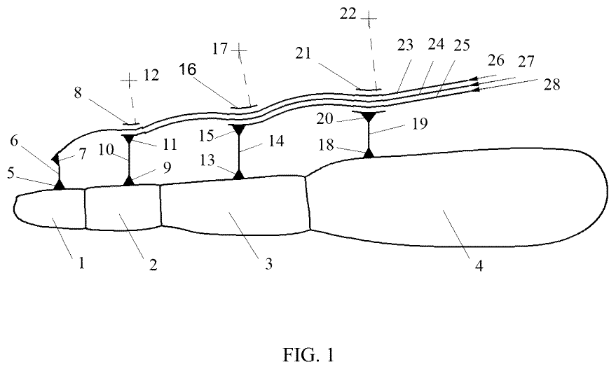

A first aspect of the present disclosure provides an elastic member driven finger exoskeleton mechanism. Referring to FIGS. 1 to 8, the finger exoskeleton mechanism includes: an elastic driving member disposed at a side adjacent to a back of a hand; and a plurality of links. The elastic driving member is extendable and retractable and capable of bending and rotating. One end of the link forms a hand fixation pair with a finger segment and a palm. The other end of the link forms an elastic driving member fixation pair with an end portion of the elastic driving member. The other end of the link forms a composite kinematic pair with a non-end portion of the elastic driving member. The composite kinematic pair is configured to cause the elastic driving member to perform flexion and extension movement. The elastic driving member has the following working states:

A bending movement working state, where when the driving member drives the elastic driving member to extend, the elastic driving member performs a bending movement toward a direction of a palm center;

An extension movement working state, where when the driving member drives the elastic driving member to retract, the elastic driving member performs an extension movement toward a direction away from the palm center.

In the finger exoskeleton mechanism provided by the present disclosure, the link forms the hand fixation pair at the finger segment (e.g., a distal phalanx, a middle phalanx, a proximal phalanx) or the palm 4, and does not need to be aligned with a finger joint, which is convenient for wearing. Compared with aligning the link with the finger joint to form a fixed pair, achieving alignment of the link with the finger segment is relatively easy, reducing a probability of occurrence of misalignment during use, improving comfort of a user, and avoiding damaging the finger joint. Meanwhile, this also allows the finger exoskeleton mechanism to have better compatibility with different sizes of hands. When hand sizes of different users change, there is no need to customize or replace components in the finger exoskeleton mechanism, saving economic costs. Moreover, as described above, the bending of the finger is achieved by the extension of the elastic driving member increasing a curve length between two elastic driving member fixation pairs. Thus, by increasing the length of the elastic driving member between different elastic driving member fixation pairs, different finger joints may be bent, thereby accommodating needs of different rehabilitation treatments. Based on this, the finger exoskeleton mechanism provided by the present disclosure may further achieve independent control of bending of different finger joints to achieve more postures of the hand.

In some embodiments, the number of the hand fixation pairs may be 3 or 4, to correspond to the number of segments of the finger and the palm. For example, when the finger exoskeleton mechanism provided by the present disclosure is worn on a thumb, the numbers of the hand fixation pairs, the elastic driving member fixation pairs, and the links are all 3, to be respectively connected to two finger segments of the thumb and the palm 4. In other embodiments, referring to FIGS. 1 to 4, the number of the hand fixation pairs is 4, including a first fixed pair 5, a third fixed pair 9, and a seventh fixed pair 18. Generally, three finger segments of the finger are respectively named the distal phalanx 1, the middle phalanx 2, and the proximal phalanx 3 in a direction from away from the palm 4 to adjacent to the palm 4. Three joints of the finger are respectively named a distal interphalangeal joint, a proximal interphalangeal joint, and a metacarpophalangeal joint in the direction from away from the palm 4 to adjacent to the palm 4. As shown in FIGS. 1 to 4, one end of a first link 6 is connected to the distal phalanx 1 to form the first fixed pair 5, one end of a second link 10 is connected to the middle phalanx 2 to form the third fixed pair 9, one end of a third link 14 is connected to the proximal phalanx 3 to form a fifth fixed pair 13, and one end of a fourth link 19 is connected to the palm 4 to form the seventh fixed pair 18. Correspondingly, a second fixed pair 7 is formed by connecting the other end of the first link 6 with the elastic driving member, a fourth fixed pair 11 is formed by connecting the other end of the second link 10 with the elastic driving member, a sixth fixed pair 15 is formed by connecting the other end of the third link 14 with the elastic driving member, and an eighth fixed pair 20 is formed by connecting the other end of the fourth link 19 with the elastic driving member.

Of course, specific numbers of the hand fixation pairs, the elastic driving member fixation pairs, and the links may be adjusted according to actual rehabilitation needs. For example, if rehabilitation treatment is only needed for the metacarpophalangeal joint, the numbers of the hand fixation pairs, the elastic driving member fixation pairs, and the links are two, and two links are respectively connected to the palm 4 and the proximal phalanx 3.

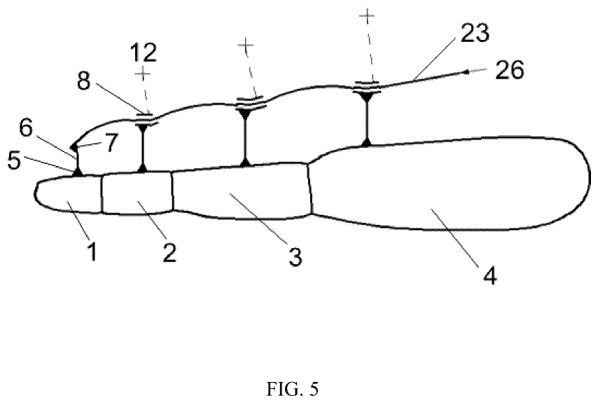

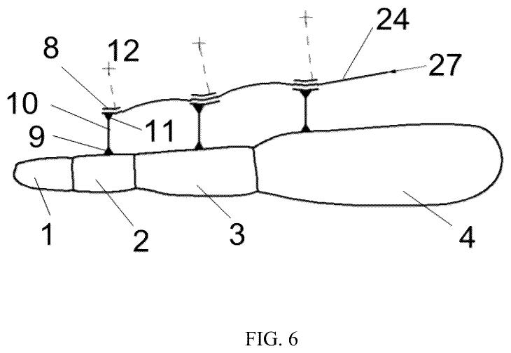

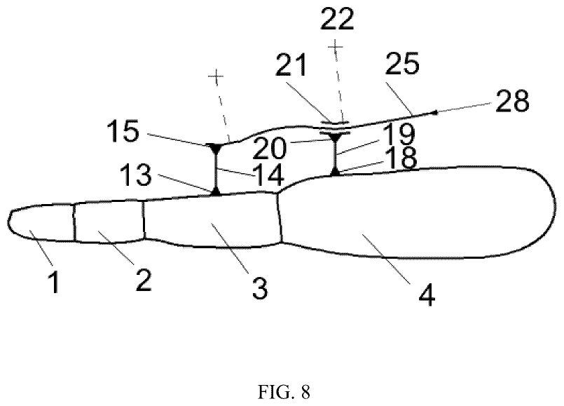

In some embodiments, the finger exoskeleton mechanism further includes a moving drive. The moving drive is loaded on the elastic driving member to cause the elastic driving member to perform extension and retraction movement. The numbers of the elastic driving members and the moving drives may also be adjusted according to actual rehabilitation needs. The number of the elastic driving members may be 1 or a plurality, and the number of the moving drives may be 1 or a plurality. In some embodiments, one moving drive may be loaded to drive 1 or a plurality of elastic driving members to extend and retract, or 1 moving drive corresponds to load and drive 1 elastic driving member to extend and retract. For example, referring to FIG. 5, FIG. 6, and FIG. 8, the number of the elastic driving members is 1. As shown in FIG. 5, the elastic driving member is a first elastic driving member 23 drivingly connected to a first moving drive 26, and an end portion of the first elastic driving member 23 may form the second fixed pair 7 with the other end of the first link. As shown in FIG. 6, the elastic driving member is a second elastic driving member 24 drivingly connected to a second moving drive 27, and an end portion of the second elastic driving member 24 may form the fourth fixed pair 11 with the other end of the second link 10. As shown in FIG. 8, the elastic driving member is a third elastic driving member 25 drivingly connected to a third moving drive 28, an end portion of the third elastic driving member 25 may form the sixth fixed pair 15 with the other end of the third link 14, and the third moving drive 28 is loaded on the third elastic driving member 25 to cause the third elastic driving member 25 to extend, causing a curve length between the eighth fixed pair 20 and the sixth fixed pair 15 to increase, thereby causing the proximal phalanx 3 to bend about the metacarpophalangeal joint.

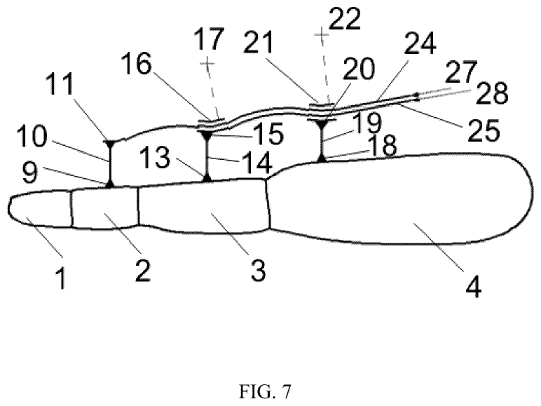

In some embodiments, referring to FIG. 7, the elastic driving members include the second elastic driving member 24 drivingly connected to the second moving drive 27 and the third elastic driving member 25 drivingly connected to the third moving drive 28. The end portion of the second elastic driving member 24 forms the fourth fixed pair 11 with the other end of the second link 10. A non-end portion of the second elastic driving member 24 forms composite kinematic pairs at the other end of the third link 14 and the other end of the fourth link 19, respectively. The end portion of the third elastic driving member 25 forms the sixth fixed pair 15 with the other end of the third link 14. A non-end portion of the third elastic driving member 25 forms a composite kinematic pair with the other end of the fourth link 19.

In some embodiments, referring to FIGS. 1 to 4, the elastic driving members include the first elastic driving member 23, the second elastic driving member 24, and the third elastic driving member 25 respectively drivingly connected to the first moving drive 26, the second moving drive 27, and the third moving drive 28. The end portion of the first elastic driving member 23 forms the second fixed pair 7 with the other end of the first link 6. The end portion of the second elastic driving member 24 forms the fourth fixed pair 11 with the other end of the second link 10. The end portion of the third elastic driving member 25 forms the sixth fixed pair 15 with the other end of the third link 14. The first elastic driving member 23, the second elastic driving member 24, and the third elastic driving member 25 form the composite kinematic pair at the other end of the fourth link 19. The first elastic driving member 23 and the second elastic driving member 24 form the composite kinematic pair at the other end of the third link 14. The first elastic driving member 23 forms the composite kinematic pair at the other end of the second link 10.

In some embodiments, the composite kinematic pairs include a first composite kinematic pair formed by connecting the second link 10 and the first elastic driving member 23, a second composite kinematic pair formed by connecting the third link 14 with the first elastic driving member 23 and the second elastic driving member 24, and a third composite kinematic pair formed by connecting the fourth link 19 with the first elastic driving member 23, the second elastic driving member 24, and the third elastic driving member 25.

In some embodiments, rotation performed by the elastic driving member via the composite kinematic pair may be rotation about a center of rotation and/or rotation about a central axis of the elastic driving member.

In some embodiments, the composite kinematic pair includes a translation and rotation composite pair. The elastic driving member is configured to be capable of performing axial movement and rotation about a center of rotation via the translation and rotation composite pair. The center of rotation is located at the side adjacent to the back of the hand or a side adjacent to the palm center. Preferably, the center of rotation is located at the side adjacent to the back of the hand. Thus, when the driving member drives the elastic driving member to extend, the elastic driving member moves axially toward the distal phalanx 1 via the translation and rotation composite pair. Meanwhile, since the center of rotation is located at the side adjacent to the back of the hand, when the elastic driving member moves axially out of the translation and rotation composite pair, the elastic driving member bends and rotates toward a direction away from the back of the hand, avoiding deformation toward the finger surface to damage the finger, and also increasing a driving torque of the finger joint.

In some embodiments, the composite kinematic pair includes a cylindrical and rotation composite pair. The elastic driving member is configured to be capable of performing axial movement and rotation via the cylindrical and rotation composite pair. The rotation includes rotation about a center of rotation and rotation about a central axis of the cylindrical and rotation composite pair. The center of rotation is located at the side adjacent to the back of the hand or the side adjacent to the palm center.

The composite kinematic pairs include the first composite kinematic pair formed by connecting the second link 10 and the first elastic driving member 23, the second composite kinematic pair formed by connecting the third link 14 with the first elastic driving member 23 and the second elastic driving member 24, and the third composite kinematic pair formed by connecting the fourth link 19 with the first elastic driving member 23, the second elastic driving member 24, and the third elastic driving member 25.

Referring to FIGS. 1 to 4, the cylindrical and rotation composite pairs include a first cylindrical and rotation composite pair 8 formed by connecting the second link 10 and the first elastic driving member 23, a second cylindrical and rotation composite pair 16 formed by connecting the third link 14 with the first elastic driving member 23 and the second elastic driving member 24, and a third cylindrical and rotation composite pair 21 formed by connecting the fourth link 19 with the first elastic driving member 23, the second elastic driving member 24, and the third elastic driving member 25. A first center of rotation 12 of the first cylindrical and rotation composite pair 8, a second center of rotation 17 of the second cylindrical and rotation composite pair 16, and a third center of rotation 22 of the third cylindrical and rotation composite pair 21 are located at the side adjacent to the back of the hand. One end of the first elastic driving member 23 is drivingly connected to the first moving drive 26, and the other end extends from the palm 4 toward the distal phalanx 1 to be connected to the second fixed pair 7. One end of the second elastic driving member 24 is drivingly connected to the second moving drive 27, and the other end extends from the palm 4 toward the middle phalanx 2 to be connected to the fourth fixed pair 11. One end of the third elastic driving member 25 is drivingly connected to the third moving drive 28, and the other end extends from the palm 4 toward the proximal phalanx 3 to be connected to the sixth fixed pair 15.

In some embodiments, the elastic driving member is made of a polytetrafluoroethylene material, reducing resistance of bending and rotating generated by the elastic driving member, thereby reducing a magnitude of a required driving torque. Meanwhile, the elastic driving member made of the polytetrafluoroethylene material makes the obtained finger exoskeleton lightweight and manufacturing cost low.

It should be noted that the elastic driving member may bend and deform about the rotating shaft of the finger joint, for example, bend and rotate toward or away from the direction of the palm center, and may also deform about a direction perpendicular to the rotation direction of the joint, for example, drive the finger to perform open and close movement. That is, wearing the finger exoskeleton mechanism provided by the present disclosure allows a certain degree of opening and closing between fingers of the hand.

A specific process of the finger exoskeleton mechanism provided by the present disclosure driving the finger to bend and extend is specifically described below with reference to the accompanying drawings:

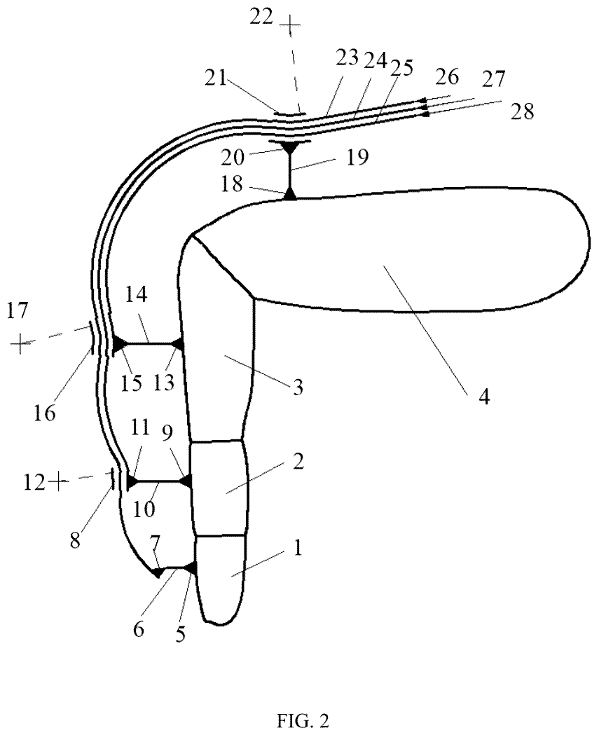

First, referring to FIG. 2, the first moving drive 26, the second moving drive 27, and the third moving drive 28 synchronously drive the first elastic driving member 23, the second elastic driving member 24, and the third elastic driving member 25 to extend respectively, causing a curve length between the third cylindrical and rotation composite pair 21 and the second cylindrical and rotation composite pair 16 to increase, causing the first elastic driving member 23, the second elastic driving member 24, and the third elastic driving member 25 to deform and bend and rotate toward the direction of the palm center, and driving the proximal phalanx 3 to bend and rotate about the palm 4.

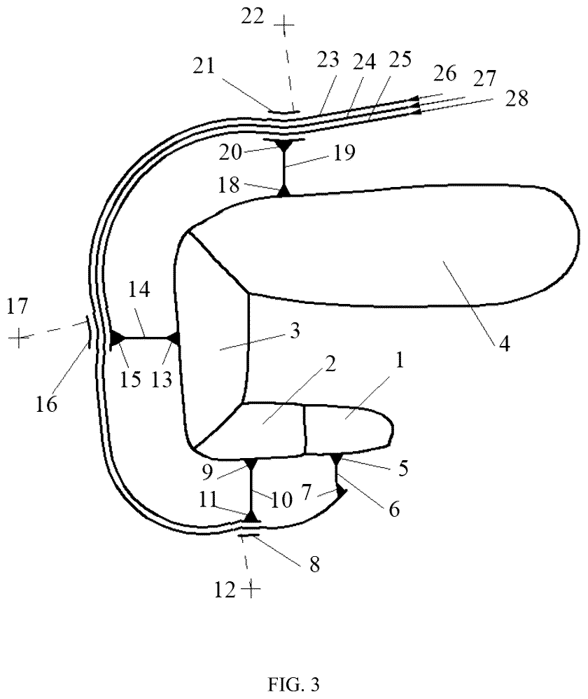

Next, referring to FIG. 3, the first moving drive 26 and the second moving drive 27 synchronously drive the first elastic driving member 23 and the second elastic driving member 24 to extend, causing a curve length between the first cylindrical and rotation composite pair 8 and the second cylindrical and rotation composite pair 16 to increase, causing the first elastic driving member 23 and the second elastic driving member 24 to deform and bend and rotate toward the direction of the palm center, and driving the middle phalanx 2 to bend and rotate about the proximal phalanx 3.

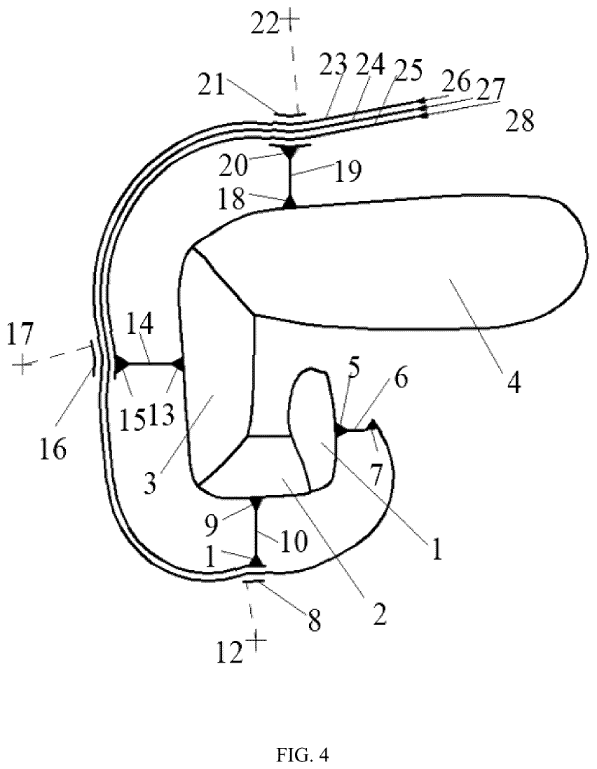

Then, referring to FIG. 4, the first moving drive 26 drives the first elastic driving member 23 to extend, causing a curve length between the first cylindrical and rotation composite pair 8 and the second fixed pair 7 to increase, causing the first elastic driving member 23 to deform and bend and rotate toward the direction of the palm center, and driving the distal phalanx 1 to bend and rotate about the middle phalanx 2.

A process of the finger exoskeleton mechanism provided by the present disclosure driving the finger to extend is opposite to the above finger bending process. First, the first moving drive 26, the second moving drive 27, and the third moving drive 28 synchronously drive the first elastic driving member 23, the second elastic driving member 24, and the third elastic driving member 25 to retract, causing the curve length between the third cylindrical and rotation composite pair 21 and the second cylindrical and rotation composite pair 16 to decrease, causing the first elastic driving member 23, the second elastic driving member 24, and the third elastic driving member 25 to deform and bend and rotate toward the direction away from the palm center, and driving the proximal phalanx 3 to extend and rotate about the palm 4.

Next, the first moving drive 26 and the second moving drive 27 synchronously drive the first elastic driving member 23 and the second elastic driving member 24 to retract, causing the curve length between the first cylindrical and rotation composite pair 8 and the second cylindrical and rotation composite pair 16 to decrease, causing the first elastic driving member 23 and the second elastic driving member 24 to deform and perform bending movement toward the direction away from the palm center, and driving the middle phalanx 2 to extend and rotate about the proximal phalanx 3.

Then, the first moving drive 26 drives the first elastic driving member 23 to retract, causing the curve length between the first cylindrical and rotation composite pair 8 and the second fixed pair 7 to decrease, causing the first elastic driving member 23 to deform and bend and rotate toward the direction away from the palm center, and driving the distal phalanx 1 to perform extension movement about the middle phalanx 2.

The finger exoskeleton mechanism provided by the present disclosure may enable three joints of the finger to achieve any flexion and extension angle by controlling driving ratios and directions of the first moving drive 26, the second moving drive 27, and the third moving drive 28, thereby achieving any flexion and extension posture of the finger.

A second aspect of the present disclosure provides an elastic member driven hand exoskeleton mechanism, including a plurality of the elastic member driven finger exoskeleton mechanisms described above. The plurality of finger exoskeleton mechanisms are correspondingly mounted to different fingers. The number of the finger exoskeleton mechanisms may be adjusted according to treatment needs of a patient. For example, the number of the finger exoskeleton mechanisms is two, respectively worn on an index finger and a middle finger of the patient, or the number of the finger exoskeleton mechanisms is 5, respectively worn on five fingers of the patient.

The finger exoskeleton mechanism and the hand exoskeleton mechanism provided by the present disclosure have the following beneficial effects:
(1) Achieving many postures of the hand: The finger exoskeleton mechanism of the present disclosure has many degrees of freedom, and may realize complete bending actions of three joints of the finger. Bending of each joint may be independently controlled with higher precision. Therefore, the hand exoskeleton combined by five finger exoskeleton mechanisms may realize more postures of the hand compared with the prior art;
(2) Few driving members and simple control: Different from the cable drive in the prior art, for the elastic driving member of the present disclosure, driving patterns are the same during the flexion and extension movement of the finger, and flexion and extension of one joint of the finger may be achieved by one driving member;
(3) No need to align with the finger joint when wearing: In the present disclosure, joints of the finger are completely connected by the elastic driving member, so there is no requirement for alignment between the kinematic pair of the mechanism and the finger joint during wearing. Therefore, wearing is convenient and quick, discomfort caused by joint misalignment in the prior art is not generated, and even damage to the finger is not generated. Meanwhile, certain opening and closing of the finger is allowed, which conforms more to a physiological structure of the finger, further improving comfort during wearing and movement;
(4) Few components, simple connection relationship, lightweight, and low cost: The mechanism of the present disclosure has few components and few connection kinematic pairs, and the elastic driving member is made of the polytetrafluoroethylene material, further reducing the weight of the obtained finger exoskeleton and reducing the manufacturing cost;
(5) High ratio of generated rotational torque to driving force: The position of the center of rotation of the cylindrical and rotation composite pair above the back of the finger causes the elastic driving member to deform in the direction away from the finger surface, avoiding deformation toward the finger surface to damage the finger, increasing the driving torque of the finger joint, and increasing a gripping force of the hand exoskeleton combined by five finger exoskeletons;
(6) Various hand exoskeleton combinations: Different numbers of finger exoskeleton mechanisms may be selected to form the hand exoskeleton mechanism according to needs of the patient.

The preferred embodiments of the present disclosure are described in detail above with reference to the accompanying drawings, but the present disclosure is not limited thereto. Within the scope of the technical concept of the present disclosure, multiple simple variations may be made to the technical solution of the present disclosure, including combining various specific technical features in any suitable manner. To avoid unnecessary repetition, the present disclosure will not describe various possible combinations separately. However, these simple variations and combinations should also be regarded as the content disclosed in the present disclosure and all fall within the scope of protection of the present disclosure.

What is claimed is:

1. An elastic member driven finger exoskeleton mechanism, comprising:
an elastic driving member disposed at a side adjacent to a back of a hand and configured to extend and retract and perform flexion and extension movement; and
a plurality of links, wherein for each link of the plurality of links, a first end of the link forms a hand fixation pair with a corresponding finger segment or a palm 4, and a second end of the link forms an elastic driving member fixation pair with an end portion of a corresponding elastic driving member; and wherein a non-end portion of at least one elastic driving member forms a composite kinematic pair with at least one of the links, the composite kinematic pair being configured to cause the elastic driving member to perform the flexion and extension movement; wherein the elastic driving member has following working states:
a bending working state, wherein when the elastic driving member extends, the elastic driving member performs a bending movement toward a direction of a palm center; and
an extension working state, wherein when the elastic driving member retracts, the elastic driving member performs an extension movement toward a direction away from the palm center;
wherein the hand fixation pair comprises a first fixed pair 5 formed by connecting a distal phalanx 1 and a first link 6, a third fixed pair 9 formed by connecting a middle phalanx 2 and a second link 10, a fifth fixed pair 13 formed by connecting a proximal phalanx 3 and a third link 14, and a seventh fixed pair 18 formed by connecting the palm 4 and a fourth link 19;
wherein the elastic driving member fixation pair comprises a second fixed pair 7, a fourth fixed pair 11, a sixth fixed pair 15, and an eighth fixed pair 20 formed by connecting the elastic driving member with the first link 6, the second link 10, the third link 14, and the fourth link 19, respectively; and
wherein the elastic driving member comprises a first elastic driving member 23 having an end portion connected to the first link 6 to form the second fixed pair 7, a second elastic driving member 24 having an end portion connected to the second link 10 to form the fourth fixed pair 11, and a third elastic driving member 25 having an end portion connected to the third link 14 to form the sixth fixed pair 15.

2. The elastic member driven finger exoskeleton mechanism according to claim 1, wherein the composite kinematic pair comprises a first composite kinematic pair formed by connecting the second link 10 and the first elastic driving member 23, a second composite kinematic pair formed by connecting the third link 14 with the first elastic driving member 23 and the second elastic driving member 24, and a third composite kinematic pair formed by connecting the fourth link 19 with the first elastic driving member 23, the second elastic driving member 24, and the third elastic driving member 25.

3. The elastic member driven finger exoskeleton mechanism according to claim 1, further comprising a moving drive, wherein the moving drive is loaded on the elastic driving member to cause the elastic driving member to perform extension and retraction movement.

4. The elastic member driven finger exoskeleton mechanism according to claim 3, wherein the moving drive comprises a first moving drive 26 loaded on the first elastic driving member 23, a second moving drive 27 loaded on the second elastic driving member 24, and a third moving drive 28 loaded on the third elastic driving member 25.

5. The elastic member driven finger exoskeleton mechanism according to claim 1, wherein the composite kinematic pair comprises a translation and rotation composite pair, wherein the translation and rotation composite pair is configured to cause the elastic driving member to perform axial movement and flexion and extension movement.

6. The elastic member driven finger exoskeleton mechanism according to claim 1, wherein the composite kinematic pair comprises a cylindrical and rotation composite pair, wherein the cylindrical and rotation composite pair is configured to be capable of causing the elastic driving member to perform axial movement, flexion and extension movement, and rotation about a central axis of the cylindrical and rotation composite pair.

7. The elastic member driven finger exoskeleton mechanism according to claim 1, wherein the elastic driving member is made of a polytetrafluoroethylene material.

8. An elastic member driven hand exoskeleton mechanism, comprising a plurality of the elastic member driven finger exoskeleton mechanisms according to claim 1, wherein the plurality of finger exoskeleton mechanisms are correspondingly mounted to different fingers.
